(19) United States
(12) Patent Application Publication
(10) Pub. No.: US 2026/0346348 A1
(43) Pub. Date: Nov. 5, 2026

(54) QUICK SETUP SELECTABLE PRECISION CUTTING GUIDE SYSTEM

(71) Applicant: Michael Donnell, Sandy, UT (US)

(72) Inventor: Michael Donnell, Sandy, UT (US)

(21) Appl. No.: 19/547,285

(22) Filed: Feb. 23, 2026

Related U.S. Application Data
(60) Provisional application No. 63/761,759, filed on Feb. 21, 2025.

(51) Int. Cl. B23D 47/02; B23D 47/04; B23D 59/00

(52) U.S. Cl. CPC B23D 47/025; B23D 47/04; B23D 59/001

(57) ABSTRACT

Portable digital precision guide systems adapted for quick set up and takedown. One illustrative system includes a collapsible table for a power tool, such as a miter saw, and at least a first collapsible stand attachment guide table including a table surface member and a fence member. An adjustable quick connect assembly secures the stand attachment guide table to the tool stand. Additional collapsible stand attachment guide table sections may be quickly joined to the first section or subsequent sections to allow a system of desired length to be quickly assembled. Spring actuated locking assemblies that secure insertable tabs are used to secure guide table sections and the table stand together. The system further includes a deployable stop as well as its associated drive elements which are quickly adjustable to the number of guide table sections present.

### CROSS-REFERENCE TO RELATED APPLICATION

This application claims the benefit of U.S. Provisional Application No. 63/761,759, filed Feb. 21, 2025, the disclosure of which is incorporated herein by reference in its entirety.

### TECHNICAL FIELD

This disclosure relates to a digital precision cutting guide system, which can be used with woodworking, metalworking, or other type of cutting machinery and related methods, systems, and devices.

### BACKGROUND

Professional and hobby woodworkers, metalworkers, and the like use a tape measure and various saws to get an accurate measured cut. Miter saws typically range in cost from $100 to over $1,500 without accessories and are used to cut a variety of materials. Numerous accessories are available to enhance the saw's functionality, including built in measuring tools (e.g., laser cutting indicators), production stops, and work clamps. These accessories are designed to increase accuracy, ease of use, and speed of production.

Accurate measurements are critical, particularly with precision woodworking and metalworking. The introduction of human error has made the ability to obtain an accurate cut prone to error. These errors can be compounded when measurements are at atypical lengths (e.g., increments of fractions of an inch), or include a non-right-angle cuts either horizontally, vertically, or both.

Current guide systems are typically complex specialty equipment used at a central fabrication site, rather than for portability and use at jobsites. These systems are also expensive, placing them out of reach of casual users and many small contractors and carpenters. A guide system designed for quick setup and takedown at jobsites would be an improvement in the art.

### SUMMARY

The disclosure describes digital precision guide systems that can be used with various cutting machinery (e.g., miter saws, table saws, band saws, or other cutting devices) to obtain accurate and precise measured cuts on a piece of material even when the cuts are being made at atypical lengths or include non-right angle cuts. While the below disclosure primarily describes aspects of the invention with respect to woodworking machinery, the concepts of the digital precision guide system can be used in other applications, including metalworking or other activities that require accurate and precise measured cuts.

In some examples, the disclosure describes portable digital precision guide systems that are adapted for quick set up for use and collapse for transport or storage. In one illustrative embodiment, the system is configured for attachment includes a collapsible table or stand for a power tool, such as a miter saw, and at least a first collapsible stand attachment guide table including a table surface member and a fence member for supporting and guiding a workpiece to the power tool, an adjustable quick connect assembly for securing the stand attachment guide table to the tool stand, and at least one collapsible leg assembly. In some embodiments, additional collapsible stand attachment guide table sections, each including a table surface member and adjoining fence member as well as a collapsible leg assembly may be quickly joined to the first section or subsequent sections to allow a system of desired length to be quickly assembled.

The system further includes a deployable stop mechanism that moves along a track on the fence member to position a workpiece for cutting, as well as its associated drive elements which are quickly adjustable to the number of guide table sections present and selected for use. In illustrative embodiments, spring actuated locking assemblies that secure insertable tabs are present to secure guide table sections together. Each section may include pulleys and suitable drive belts may be installed for actuating the moveable stop. The table stand may include adjustable locking elements for securing to the attachment guide table such that the height of a supported tool and the attachment guide table are maintained for use. The stop itself may be removable, allowing the system to be used as a support table for cuts without the precision guide features. In some embodiments, system may include an embedded wiring harness in the guide table sections to provide connectivity to components, such as a limit switch located at a distal end. In some embodiments, pins or members used to align the guide table sections may also be electrically conductive to support strength as well as allow a signal or power to pass therethrough. In some embodiments, the alignment members may contain and protect conductive contacts that allow a signal power to pass therethrough.

In some examples, the disclosure describes methods for calculating and making cuts for usable material on the side of a saw blade opposite the stop mechanism. Additionally, in some examples, the system may be used in novel methods of cutting crown molding that are safer and easier for a user.

The features and advantages of the disclosure will be set forth in the description, which follows, and in part will be apparent from the description, or may be learned by the practice of the disclosure without undue experimentation. The features and advantages of the disclosure may be realized and obtained by means of the instruments and combinations including those pointed out in the appended claims. Any discussion of documents, acts, materials, devices, articles, or the like, which has been included in the specification is not to be taken as an admission that any or all these matters form part of the prior art base or were common general knowledge in the field relevant to the disclosure as it existed before the priority date of each claim of this disclosure.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. Advantages of the disclosure will become better understood with regard to the following description and accompanying drawings where:

FIGS. 1A and 1B are front and rear perspective views of a first illustrative embodiment of an example digital precision guide system in accordance with the present disclosure, in position with a power miter saw on a table stand, without the stop member for illustrating certain components.

FIG. 1C is a front view of the system of FIGS. 1A and 1B attached to the table stand without the power miter saw.

FIG. 1D. is a side perspective view of the system of FIGS. 1A and 1B attached to the table stand showing the stop member and an attached power miter saw.

FIGS. 2A and 2B depict an assembled and exploded view of a quick connect system for attaching a table stand to a collapsible stand attachment guide table assembly that may be used with the digital precision guide system of FIGS. 1A-1D.

FIG. 3 depicts a rear view of a quick connect arrangement between collapsible stand attachment guide table assemblies that may be used with the digital precision guide system of FIGS. 1A-1D, in an unassembled conformation.

FIG. 4A generally illustrates a suitable wiring harness conformation in a table section.

FIGS. 4B and 4C depict one set of exemplary interconnection arrays for the conformation of FIG. 4A.

FIGS. 5A and 5B depict an assembled and exploded view of a quick connect end member in position for connection to a collapsible stand attachment guide table assembly that may be used with the digital precision guide system of FIGS. 1A-1D.

FIG. 5C depicts the quick connect end member of FIGS. 5A and 5B connected for use to a collapsible stand attachment guide table assembly that may be used with the digital precision guide system of FIGS. 1A-1D.

FIGS. 6A and 6B, depict components for forming portions of the collapsible stand attachment guide table assembly that may be used with the digital precision guide system of FIGS. 1A-1D.

FIG. 7 is rear perspective view depicting some assembled drive components for a deployable stop mechanism for the digital precision guide system of FIGS. 1A-1D.

FIGS. 8A, 8B and 8C depict components of the deployable stop mechanism in isolation and as part of the digital precision guide system of FIGS. 1A-1D.

FIGS. 9A, 9B and 9C depict exemplary informational displays that may be provided on a control panel for a user using a system in accordance with the present disclosure to have the system calculate and set up specific cutting designs.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims or described in this disclosure.

### DETAILED DESCRIPTION

The disclosure extends to methods, systems, and devices for precision guide systems and devices for use with cutting machines. In the following description of the disclosure, reference is made to the accompanying drawings, which form a part hereof, and in which is shown by way of illustration specific implementations in which the disclosure may be practiced. It is understood that other implementations may be utilized, and structural changes may be made without departing from the scope of the disclosure. This provisional application further includes an appendix showing additional views of components of systems in accordance with the present disclosure, such appendix forms part of this disclosure.

Before the methods, systems and devices of the present disclosure are discussed and described, it is to be understood that this disclosure is not limited to the particular configurations, process steps, and materials disclosed herein as such configurations, process steps, and materials may vary somewhat. It is also to be understood that the terminology employed herein is used for the purpose of describing implementations only and is not intended to be limiting since the scope of the disclosure will be limited only by the appended claims and equivalents thereof.

In describing and claiming the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

Applicant's co-pending U.S. patent application Ser. No. 18/048,550, filed Oct. 21, 2022, and entitled Precision Cutting Guide System, is incorporated by reference herein in its entirety. It will be appreciated that the quick assembly systems of the present disclosure may be useful with the Precision Cutting Guide Systems disclosed therein.

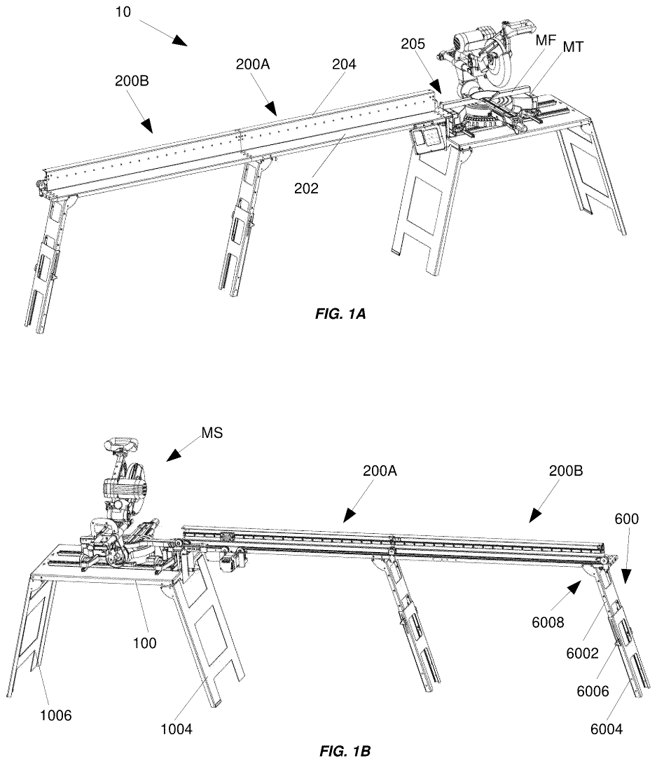

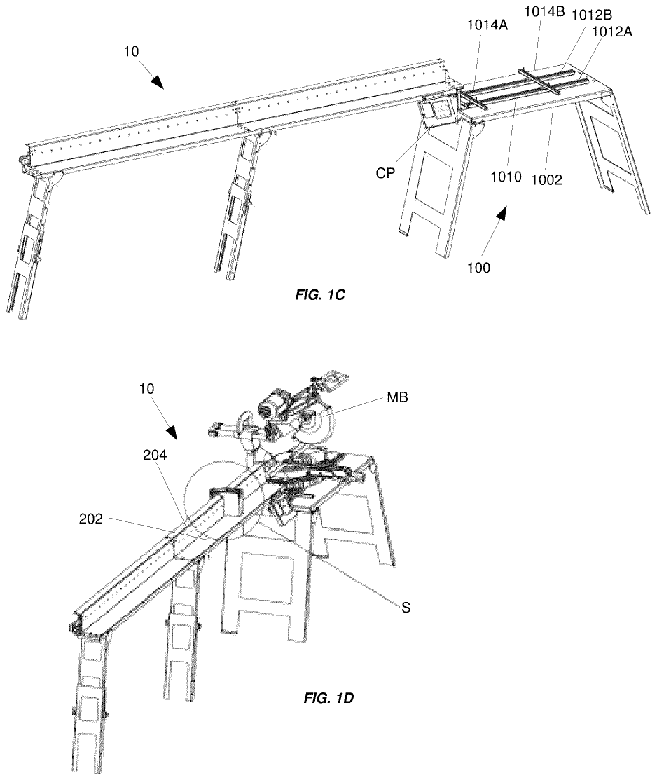

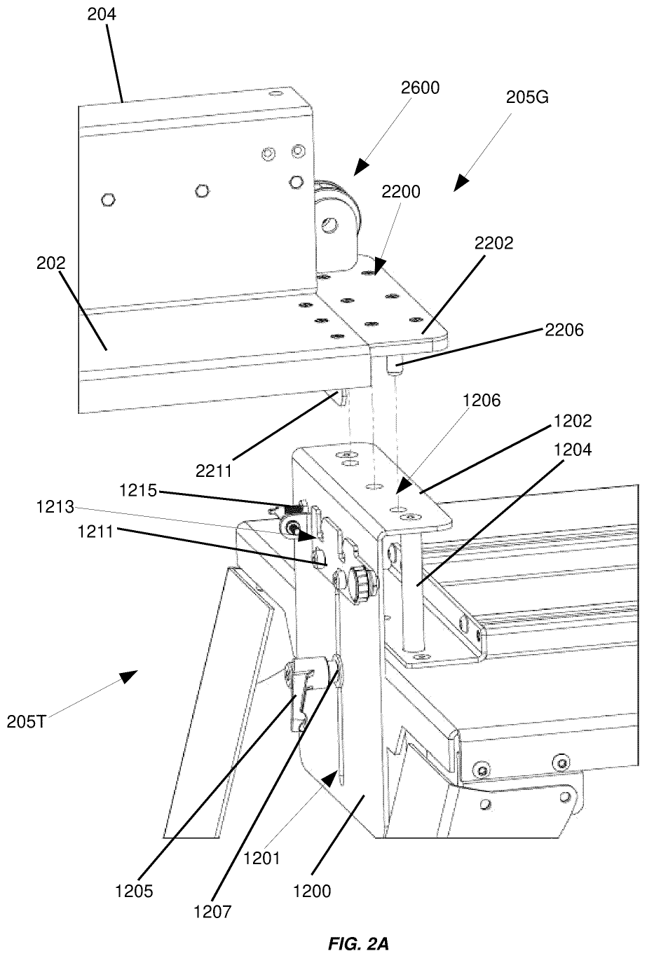

Turning to FIGS. 1A through 1D, one exemplary quick setup digital precision guide system 10 that can be incorporated with a machine cutting device (e.g., miter saw MS) to obtain accurate and precise cuts within a workpiece is depicted. While the machine cutting device is illustrated as miter saw MS, precision guide system 10 can be used with other cutting devices including, for example, table saws, band saws, radial arm saws, and the like. Miter saw MS includes base MT, fence MF, and blade MB.

At a first end, the depicted illustrative embodiment of system 10 includes a collapsible table or stand 100 for a power tool, such as miter saw MS. At one side a first collapsible stand attachment guide table assembly 200A including a table surface member 202 and a fence member 204 for supporting and guiding a workpiece to the power tool, an adjustable quick connect assembly 205 for securing the stand attachment guide table 200 to the tool stand 100, and at least one collapsible leg assembly 600. As depicted, one or more additional collapsible stand attachment guide table sections, such as that depicted at 200B may be quickly joined to the first section or subsequent sections to allow a system of desired length to be quickly assembled. As best depicted in FIG. 1D, when installed and positioned for use a stop member S resides in the workpiece support area and defines a distance from its side adjacent the power tool to the blade MB,

As depicted, table 100 includes an upper planar deck 1002 with an upper surface 1010 on which structures for attachment of a power tool are disposed. In the depicted embodiment, these structures are the depicted fixed attachment rails 1012A and 1012B attached to the upper surface 1010 and adjustable attachment rails 1014A and 1014B disposed thereon.

At either end of stand 100, a folding leg assembly 1004 or 1006 is hingedly attached to allow the stand to be folded down to a storage or transport conformation or arranged in a deployed position for use. Each leg assembly is preferably lockable to maintain the deployed or stored conformation.

Each leg assembly 1004 or 1006 may have an adjustable length, allowing systems in accordance with the present disclosure to be used with tools requiring different heights for operation or for adjustment to specific locations of use.

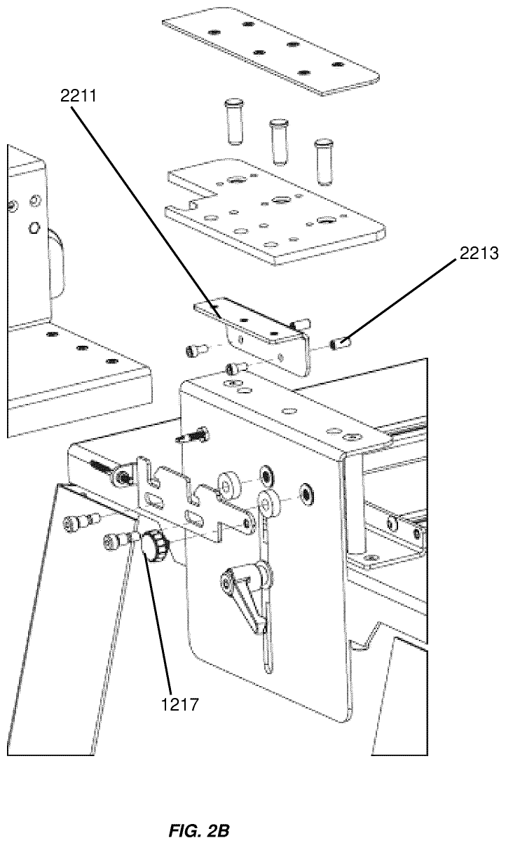

At a first end, the first collapsible stand attachment guide table assembly 200A is depicted with quick connect assembly 205. FIGS. 2A and 2B depict one illustrative embodiment of a suitable quick connect assembly 205. As depicted, quick connect assembly 205 includes table stand side components 205T and guide table components 205G.

The table side components 205T include a height adjustable plate 1200, having a planar front face disposed parallel to the side of the first end of table 100 and a top face or plate 1202 at an upper end thereof that extends at generally right angle therefrom towards and over a portion of the table 100. One or more reinforcing rods 1204 may extend from the top plate 1202 to receiving recesses in the table 100. A retaining system for keeping the height adjustable plate in a desired position is present. In the depicted embodiment, such a system includes tightening knob 1205 and retaining ring 1207 may be disposed in front of from face 1202 on a member extending through slot 1201 in the front face. The height adjustable plate 1200 may be moved to a desired height to place the table surface member 202 of the collapsible stand attachment guide table assembly 200A coplanar with table on a power tool, such as table MB on miter saw MS, and then retained in that position. For example, by turning tightening knob 1205 on a threaded member securing ring 1207 against the face of the adjustable height plate 1200.

A series of alignment recesses 1206 are disposed in top plate 1202. A slidable guide table securing assembly 1210, includes a slidable plate 1211, attached to the side of the height adjustable plate 1200 by one more pins passing through slots allowing it to slide orthogonally to the plate. L-shaped receiving slots 1213 open at an upper edge of the sliding plate. Spring 1215 connected to a tab on the plate provides tension to keep the plate in a securing position. A knob 1217 may be present to actuate the sliding plate.

Guide table components 205G include an end member 2200 for attachment to a first end of the guide table member 200A. End member 200 extends out from the first end with a planar upper surface 2202 that is generally aligned with the table surface member 202. A wheel 2600 may be disposed on a tab present on the upper surface 2202 at a position behind the fence member 204, as discussed further herein.

A series of alignment members 2206 extend from a lower surface of the end member 2200. Additionally, a locking plate 2211 extends down from the lower surface parallel, and adjacent, to the end of the table surface member 202. Securing members 2213 extend out from the locking plate. For attachment, the alignment members 1206 are inserted into recesses 2206, as slidable plate 1211 is moved to allow securing members 2213 to pass downwards therein. Upon insertion, slidable plate 1211 moves to retain the securing members in the lower portion of the slots 1213, securing the guide table to the stand 100 at the appropriate position for use.

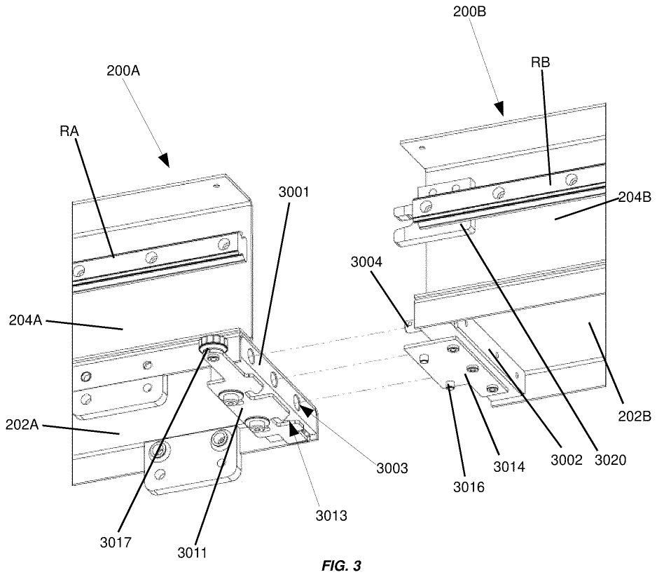

Turning to FIG. 3A, a quick connect system 300 for attachment of collapsible stand attachment guide table assemblies 200A and 200B is depicted. Fence members 204A and 204B each have a rail (RA or RB) attached to the rear surface and extending thereacross. A clip member 3020 disposed adjacent rail RB extends past the end aligned with the rail RB and having a central opening aligned with the rail. As the table sections 200A and 200B are brought together, rail RA passes into central opening and is retained in therein. Where the clip 3020 is formed of a resilient material, it may flex outwards to accept the rail RB and then maintain pressure on the rail to maintain the connection between the table assemblies.

Where the table member 204B is formed with a lower channel, a receiving connection body 3001 may be disposed in the channel aligned with the end of the table member. An outer face of the connection body 3001 may be flush with the table end and include a set of alignment holes 3003.

A slidable table assembly securing plate 3011 is attached to the lower surface of the body 3001 by one more pins passing through slots allowing it to slide orthogonally to the lower surface. L-shaped receiving slots 3013 open at the table assembly edge of the sliding plate. A spring connected to a tab on the plate provides tension to keep the plate in a securing position. A knob 3017 may be present to actuate the sliding plate.

Where the table member 204A is formed with a lower channel, a counterpart alignment connection body 3002 may be disposed in the channel aligned with the end of the table member. An outer face of the connection body 3002 may be flush with the table end and a set of alignment members 3004 corresponding to alignment holes 3003, may extend therefrom.

A table securing plate 3014 is secured to the lower surface of the connection body 3002 with a securing portion that extends past the end of table member 202B. Table securing members 3016 extend out from the locking plate. For attachment, the alignment members 3004 are inserted into recesses 3003, as slidable plate 3011 is moved to allow securing members 3016 into the receiving slots 3013. Upon insertion, slidable plate 3011 moves to retain the securing members in the lower portion of the slots 3013, securing the table assemblies 200A and 200B for use.

It will be appreciated that for embodiments where the table member 204 lacks a channel accessible on the lower surface, that portions of the components of the bodies 3001 and 3002 may be directly formed thereon or attached thereto instead of on a separate connected body.

In some embodiments, a wiring harness can connect to pins 3003 and 3004 as a passthrough for power or a signal for sensors that are incorporated into the table sections 202 for determining number of sections connected. It will be appreciated that such a wiring harness may be disposed in the guide table sections 200, where the table members 202 or fence members 204 are formed by injection molding or extrusion.

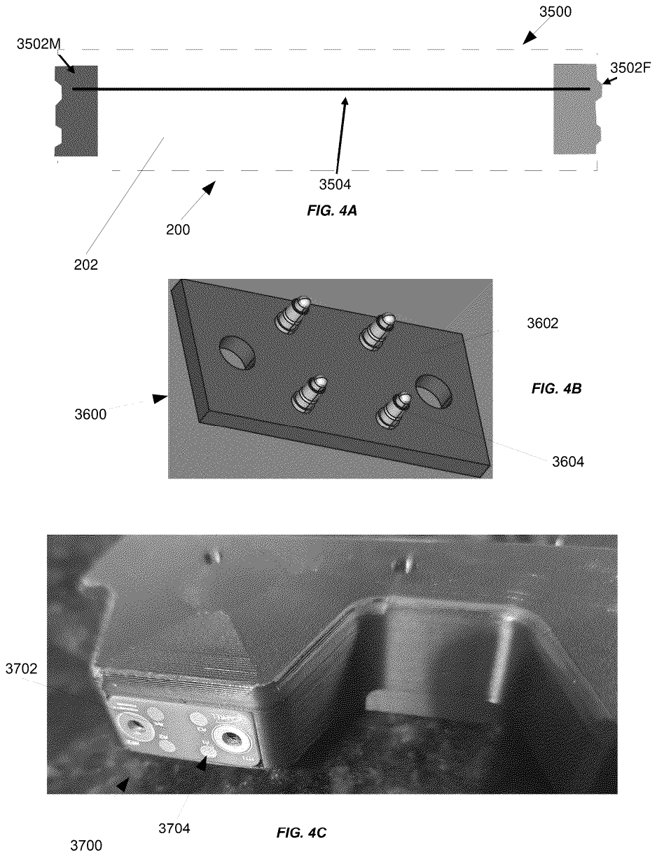

FIG. 4A generally illustrates a suitable wiring harness 3500 conformation in a table section 200. As depicted, one or more cables 3504 containing wires extends the length of the table section, embedded in a suitable protective structure of the table section 200. For example, a channel may be formed in the shelf member 202 in which the cable resides. At either end, the wires in cable 3504 are connected to a suitable interconnection assembly, such as the indicated extending array 3502M and receiving array 3502F.

One set of exemplary interconnection arrays are depicted in FIGS. 4B and 4C. As depicted in FIG. 4B, one suitable “male” interconnection assembly 3600 may have a generally planar body member 3602 with a plurality of spring-loaded electrical contact members 3604, also known as POGO pins disposed thereon. As depicted in FIG. 4C, one suitable “female” interconnection assembly 3700 may have a generally planar body member 3702 with a plurality of electrical contact members 3704 that have a planar surface that the POGO pins press against when a suitable connection is made. As depicted, the interconnection assembly may be placed adjacent to, or form part of, the alignment members and alignment member recesses.

In one suitable embodiment, each section 200 may include a proximal endcap and distal endcap, with the proximal endcap configured to mate with a distal endcap. Such endcaps may be used to align the guide rail. The proximal endcaps may contain the “male” interconnection assembly and pogo pins that mate with flat circuit board connectors in the distal endcaps to provide an electrical connection. It will be appreciated that in other embodiments, the “male” and “female” features may be in either endcap.

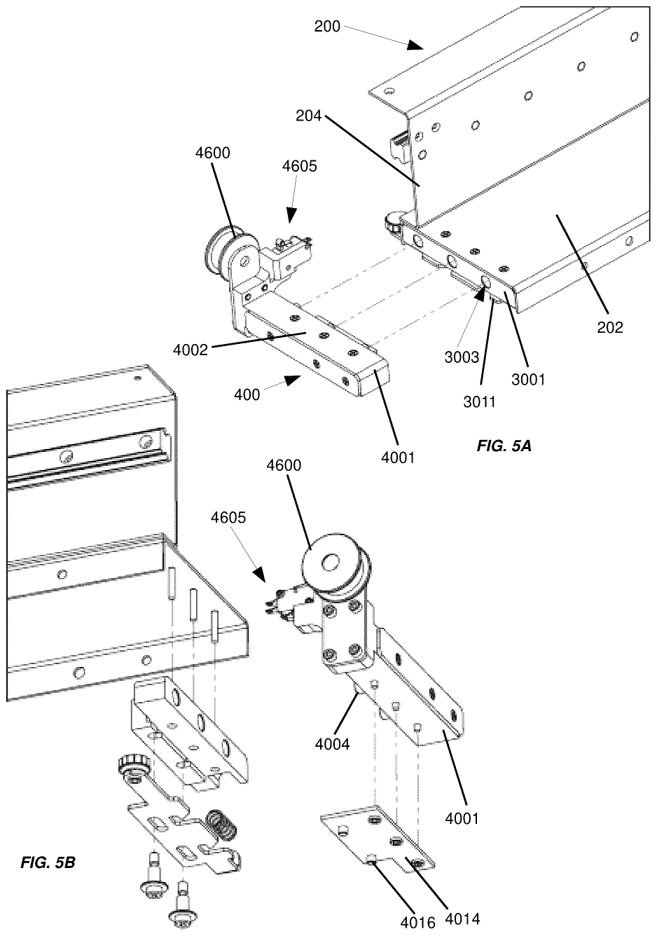

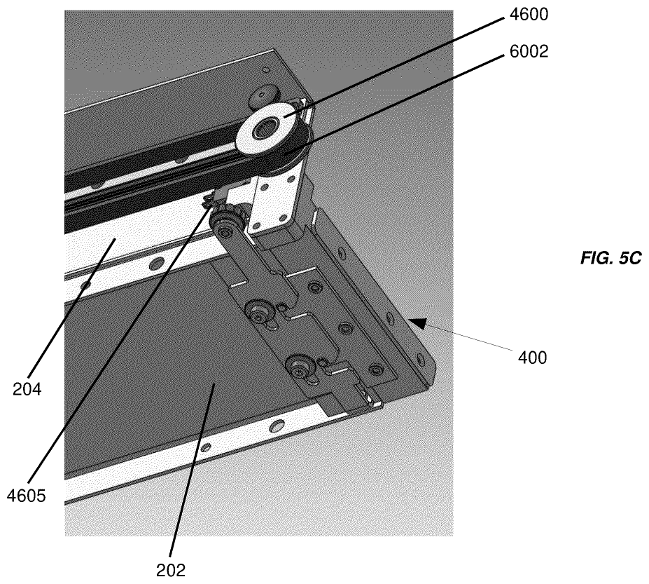

Turning to FIG. 5A. 5B, and 5B depict assembled, exploded, and installed views of a quick connect end member 400 for connection to a collapsible stand attachment guide table 200. As depicted, table 204 has a receiving connection body 3001 disposed in the lower channel thereof aligned with the end of the table member, including the set of alignment holes 3003, and slidable table assembly securing plate 3011, as discussed previously herein, is attached to the lower surface of the body 3001 by one more pins passing through slots allowing it to slide orthogonally to the lower surface.

Quick connect end member 400 includes a body 4001 with a planar upper surface that aligns with the upper surface of table member 204 upon installation. At one side a wheel 4600 may be disposed on a tab to be maintained at a position behind the fence member 204 upon installation, as discussed further herein.

The body 4000 includes a planar upper surface 4002. The connection side of body 4000 includes a set of alignment members 4004 corresponding to alignment holes 3003 extending therefrom. A table securing plate 4014 is secured to the lower surface of the body 4002 with a securing portion that extends past the end of the body. Table securing members 4016 extend out from the table securing plate. For attachment, the alignment members 4004 are inserted into recesses 3003, as slidable plate 3011 is moved to allow securing members 4016 into the receiving slots 3013. Upon insertion, slidable plate 3011 moves to retain the securing members in the lower portion of the slots 3013, securing the end member 400 to the table assemblies 200 for use. Upon installation, a belt 6002 may be installed on wheel 4600 that extends to counterpart wheel 2600 to actuate movement of the stop member, as discussed further herein.

In some embodiments, a wiring harness can connect to pins 3003 and 3004 as a passthrough for power or a signal for sensors that are incorporated into the table sections 202 for determining number of sections connected, whether a limit switch 4605 disposed on the end member 400 has been reached by the stop S or other sensors and accessories as may be included. When the end member 400 is connected, pins 4004 can connect with 3003 to provide power to any sensors in the end member. It will be appreciated that such a wiring harness may be disposed in the guide table sections 200, where the table members 202 or fence members 204 are formed by injection molding. It will be further appreciated that the wiring harness may include interconnection assemblies similar to those discussed previously herein.

In one illustrative embodiment, the wiring harness in each extension piece 200 may include 4 wires that are in cable 3504. Two of the wires are used to make an electrical connection from the controller to the limit switch 4605. The other two wires may be used in a “section detection” method. The limit switch is used to ensure that the production stop does not try to go past the final pulley point as a safety measure. The section detection method may consist of one wire with a resistor in series, the total resistance being measured by an onboard ohm meter and conveyed to the main CPU. In one example, if each resistor is 1 k ohm, and there are three resistors in series (one per section) then the computer will calculate that there are three sections connected.

It will appreciated that other suitable measuring devices can be used for section detection. Some illustrative examples include a chip with multiple different signals that can be powered by the wires such as PWM or similar signal, wiring the resistor in parallel and measuring the drop in resistance, measuring voltage instead of resistance, among others. Additionally, the distal limit switch 4605 can also be used for section detection by slowly running the stop member from the most proximal limit switch on the main rail to the furthest limit switch and measuring the distance by how far the motor moves the stop.

An RFID, a QR code, or other similar encoding method can be associated with the installed belt 6002 and can be read by a sensor tied to the main CPU. A longer belt 6002 corresponds to more sections, as a different belt length is required as different numbers of table sections are installed.

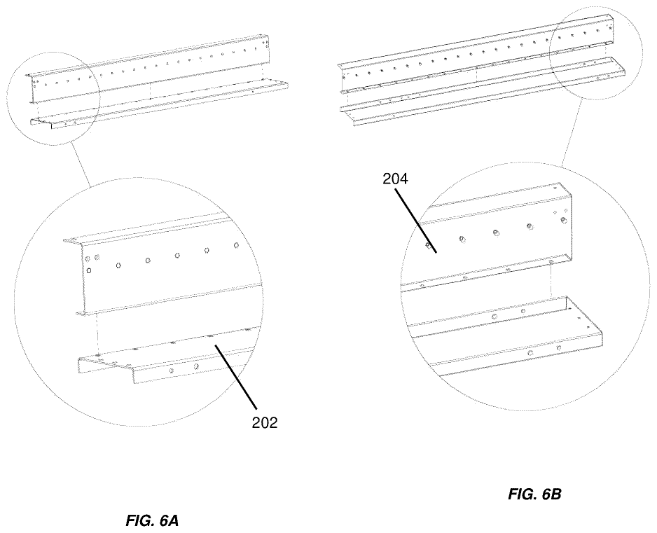

As depicted in FIGS. 6A and 6B, the collapsible stand attachment guide table assembly table portions 200 are preferably formed from separate fence 204 and table 202 members that are joined together for use. This allows the members to be formed by injection molding or extrusion. These members may also be flat packed for shipping prior to assembly.

Returning to FIG. 1B, collapsible stand attachment guide table assembly 200 includes a leg assembly 600. As depicted, leg assembly 600 is hingedly attached to the table member 202, so that upon deployment it is disposed near the end of collapsible stand attachment guide table assembly to provide support during use, and when not in use is rotated to reside near the lower portion of the table member for transport and storage. A hinge assembly 6008 may be used for such connection.

Leg assembly 600 may have an adjustable length, allowing systems in accordance with the present disclosure to be used with table stands of different heights or for adjustment to specific locations of use. In the depicted embodiment, leg assembly 600 includes an upper member 6002 and a lower member 6004, which are telescopically attached, and a locking mechanism allowing the upper and lower members to be maintained at a desired height. It will be appreciated that other embodiments having two separate legs, aligned with one another, rather than a single assembly may be used. Such embodiments may have telescoping segments.

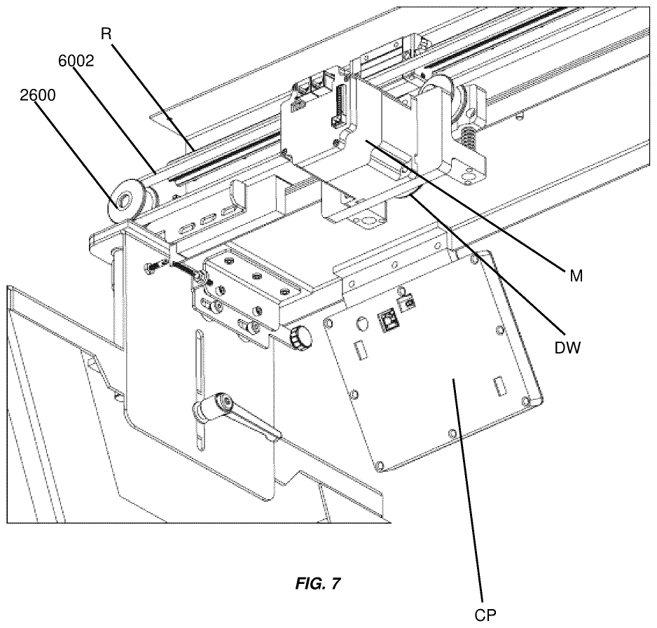

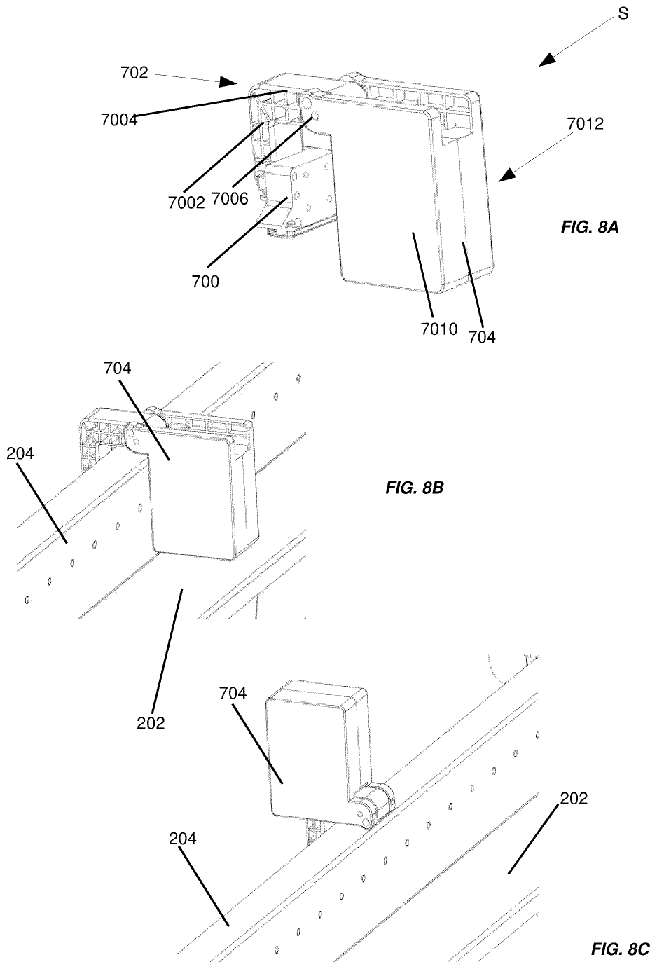

FIGS. 7, 8A, 8B, 8C and 8D depict components of the deployable stop mechanism, including the stop and drive components. As best depicted in FIG. 7, a control panel CP may be present for control of the system and may contain, or communicate with a CPU or other controller. In addition, suitable components may be present for communicating with a separate control, such as a remote control, a “smart” tape electronic or digital measuring tape, or an app operating on a mobile device, or the like, for system control.

A belt 6002 is disposed on wheels 2600 and 4600. A drive unit, such as motor assembly M with drive wheel DW, is present and moves belt 6002 as it rotates on the wheels. It will be appreciated that for setup, a user may have multiple belts of different lengths, each corresponding to the length required for a different number of collapsible table assemblies 200. For example, belts corresponding to one, two, three, or other numbers of collapsible table assemblies could be included, allowing a system to be set up in different conformation for use at different locations.

A shuttle or carriage 700 may be disposed on the belt 6002 for connection to a stop S. As depicted, the shuttle may be secured to the belt at a fixed position, as by securing the belt ends into seats on the shuttle 700. Upon installation, belt 6002 may reside near the rail R and shuttle 700 may be seated on the rail. As the system is actuated, the belt 6200 moves and shuttle 700 is placed a desired position.

As depicted in FIGS. 8A and 8B, a connection member 702 may be attached to shuttle 700. In the depicted embodiment, the connection member 702 has an upwardly extending portion 7002 and a laterally extending portion 7004. Stop member 704 is rotatably attached to the laterally extending portion 7004 with a pivot or axle 7006.

Stop member 704 is shaped to correspond to fence member 204 and table member 202, in the depicted embodiment having a generally rectangular shape. Stop member 704 has planar faces 7010 and 7012 on opposite sides, for contacting a piece being cut on a power tool.

As best depicted in FIGS. 8B and 8C, upwardly extending portion 7002 and laterally extending portion 7004 correspond to the fence member 204. Stop member 204 may be rotated to either a deployed “down” position for use as a cutting guide, or to an “up” undeployed position to allow the power tool and saw to be used without the system determining the length of the piece to be cut.

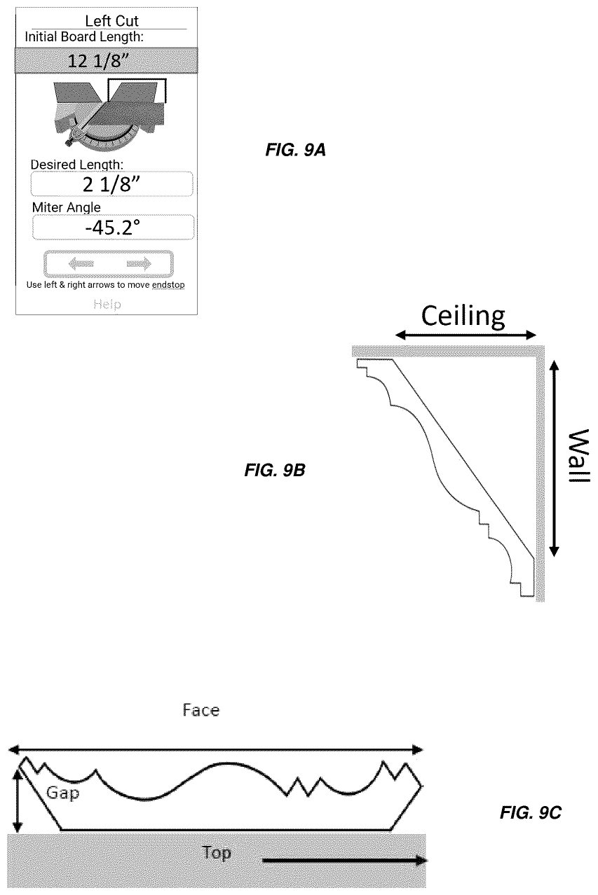

Systems in accordance with the present disclosure can be used for performing novel and unique material preparation techniques. For example, current known guide systems are designed expecting a user to cut and keep the material that is between the saw and the production stop. Systems in accordance with the present disclosure designed to work in this standard manner but additionally have the ability for the saw to calculate and perform a cut allowing the user to keep the material on the side opposite of the production stop from the saw. Using an input device, such as the control pad CP, a user enters the blade kerf (thickness), total length of the material, angle they want the cut, and final desired length of material. Where a graphic user interface is present, the user may select an image that lines up with their desired cut direction, as depicted at FIG. 9A. The use of such images can ensure that the user is pivoting the saw in the direction they are expecting as well as measuring the desired total length they are expecting as far as measuring the long side or short side of the cut. The controller then calculates the details for a cut to be performed. For example, where the final measurement has the material being placed against the fence, the offset from the saw blade equals: total length of board minus the length of the kerf and minus the desired length of the cut board. Where the final measurement has the material being away from the fence, the following equation maybe used:

Offset from saw blade=Total length of board-kerf-desired length of board±Board With*Tan(Miter angle)
where (±) is dependent on pivoting left or right.

Once the calculations are performed, the system moves the stop S to the correct position, allowing the material to be positioned and cut.

Similarly, with current methods, crown molding is often cut by flipping the material upside down, put the material in the saw and holding it at the angle that it will be installed at using the base of the saw as the “ceiling” and the fence as the “wall.” The material is then cut the angle backwards, i.e. pivot the saw left to cut the front of the material to the right. This method can be dangerous if the saw blade binds to the material and can throw the material in a wild direction, or kickback the saw. It is much safer to keep the material flat against the base of the saw and use a miter and bevel pivot angle to get a safer cut.

When cutting crown molding, or other angled cuts (i.e. for making an octagonal flowerpot with a narrower base than the top opening), systems in accordance with the present disclosure allow the user to input the shape of the material and perform more complicated calculations. Such systems may use the controller to have a separate setting for such cuts. In one exemplary example, the system is configured for cutting crown molding for use in a safer manner. In use, the user selects “crown molding” as a type of cut and is brought to a setup screen. Following the provided directions, the user will place the crown molding against a 90° angle and measure the gap made on the wall, and the gap made on the ceiling, as depicted in FIG. 9B. The wall measurement may also be called “height”, and the ceiling measurement may also be called “projection”.

After entering these measurements, the system displays another setup screen to the user where they enter the Face length and the Gap distance of the crown molding, as depicted in FIG. 9C. Once these initial measurements are entered by the user, the “spring angle” can be calculated by:

Spring Angle=ARCTAN(Wall/Ceiling)

The user will then need the angle between the walls. i.e. the Corner Angle. The system can be set up for the user to enter the total angle between wall 1 and wall 2 or set up so the user can ask for the angle to be determined by them. If they are using the Corner angle, a piece from the left and the right need to be cut so they meet in the middle, i.e. a 90° corner angle needs two 45° mitered pieces to fit properly. The corner cut angle is:

Corner Cut Angle=Angle Between Two Walls/2

The miter and bevel angle are then displayed to the user as well as a picture that shows an example of the direction of miter and bevel. These are calculated as follows:

±ARCTAN(SIN(Spring Angle)/TAN(wall angle)) Miter angle:

Bevel Angle=±ARCSIN(COS(Spring Angle)*COS(Wall Angle))
(±) is dependent on if cutting on the left side or right side of the material i.e. the left side of the corner or right side of the corner.

The stop position calculation that is used to determine where to position the production stop in relation to the saw blade is:

Stop Position=Desired Length+FACE*TAN(Miter Angle)+GAP*TAN(Bevel Angle)

Where FACE is the total width of the material when placed flat on a surface orthogonal to the length being cut, and GAP is the vertical distance from the surface to the material measured on the part that will be adjacent to the wall (not ceiling) when the material is placed on a surface. These values may be taken from those entered by a user, as explained previously in relation to FIG. 9C. Once the calculations are performed, the system moves the stop S to the correct position, allowing the crown molding material to be positioned flat on the table and against the fence and then cut. It will be appreciated that for situations where the crown molding will be installed at a location where the angle between the wall and ceiling differs from the standard 90 degrees, that user may be prompted to input the measured angle therebetween and the system adjusts the calculations accordingly.

It is to be understood that the above-described arrangements are only illustrative of the application of the principles of the disclosure. Numerous modifications and alternative arrangements may be devised by those skilled in the art without departing from the spirit and scope of the disclosure and the appended claims are intended to cover such modifications and arrangements. Thus, while the disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A portable digital precision guide system adapted for quick set up and takedown, comprising:
a collapsible table for a cutting tool, including a guide table attachment member;
at least a first collapsible stand attachment guide table including a table surface member and a fence member;
an adjustable quick connect assembly configured for securing a proximal end of the at least first collapsible stand attachment guide table to the collapsible table, comprising a first end member including a first pulley for a belt drive;
a guide rail for a moveable stop member assembly attached to the at least first collapsible stand attachment guide table;
a removable distal endcap piece configured for securing to a distal end of a collapsible stand attachment guide table and including a second pulley for distal end of the belt drive;
a moveable stop member attached to a shuttle movably disposed on the guide rail, the shuttle and connected to the belt drive; and
a controller for controlling moment of the moveable stop member.

2. The system of claim 1, further comprising at least a plurality of collapsible stand attachment guide table sections, each configured to have a proximal end quickly joined to a distal end of another collapsible stand attachment guide table.

3. The system of claim 1, wherein the guide rail is disposed on a rear surface of the fence member.

4. The system of claim 3, wherein the guide rails are attached collapsible stand attachment guide table sections connect to one another to form a continuous guide rail assembly.

5. The systems of claim 1, further comprising a proximal endcap and a distal endcap disposed on each of the collapsible stand attachment guide table sections, the proximal endcap and distal endcap having counterpart alignment members.

6. The system of claim 5, wherein the collapsible stand attachment guide table sections each include a wiring harness and the distal endcaps and proximal endcaps contain counterpart interconnection assembles for making electrical connections between the wiring harnesses of the connected collapsible stand attachment guide table sections.

7. The system of claim 6, wherein the counterpart interconnection assemblies include pogo pins disposed in a proximal endcap that mate with flat circuit board connectors in a counterpart distal endcap.

8. The system of claim 1, wherein the removable endcap further comprises a limit switch that is activated if the production stop moves too far away from a blade of a cutting tool disposed on the collapsible table for a cutting tool as a safety mechanism.

9. The system of claim 1, wherein a first spring actuated locking assembly that secures insertable tabs are used to secure the at least first collapsible stand attachment guide table section to the collapsible table for a cutting tool.

10. The system of claim 1, wherein spring actuated stand locking assemblies that secure insertable tabs are used to secure the collapsible stand attachment guide table sections to one another.

11. The system of claim 1, wherein each collapsible stand attachment guide table section further comprises at least one leg assembly that folds down for use and folds up for storage.

12. A portable digital precision guide system adapted for quick set up and takedown, comprising:
a collapsible table for a cutting tool, including a guide table attachment member;
at least a first collapsible stand attachment guide table including a table surface member and a fence member with a guide rail for a moveable stop member disposed on rear surface of the fence member;
an adjustable quick connect assembly configured for securing a proximal end of the at least first collapsible stand attachment guide table to the collapsible table, comprising a first end member including a first pulley for a belt drive;
a removable distal endcap piece configured for securing to a distal end of a collapsible stand attachment guide table and including a second pulley for distal end of the belt drive;
a moveable stop member attached to a shuttle movably disposed on the guide rail, the shuttle and connected to the belt drive;
a drive system for actuating the belt drive; and
a controller for controlling moment of the moveable stop member.

13. The system of claim 12, further comprising at least a plurality of collapsible stand attachment guide table sections, each configured to have a proximal end quickly joined to a distal end of another collapsible stand attachment guide table, such that the guide rails of the attached collapsible stand attachment guide table sections connect to one another to form a continuous guide rail assembly.

14. The system of claim 13, wherein the collapsible stand attachment guide table sections each include a wiring harness and the distal ends and proximal ends contain counterpart interconnection assembles for making electrical connections between the wiring harnesses of the connected collapsible stand attachment guide table sections.

15. The system of claim 14, wherein the counterpart interconnection assemblies include pogo pins disposed in a proximal endcap that mate with flat circuit board connectors in a counterpart distal endcap.

16. The system of claim 12, wherein the removable endcap further comprises a limit switch that is activated if the production stop moves too far away from a blade of a cutting tool secured to the collapsible table for a cutting tool.

17. The system of claim 12, wherein a first spring actuated locking assembly that secures insertable tabs are used to secure the at least first collapsible stand attachment guide table section to the collapsible table for a cutting tool.

18. The system of claim 12, wherein each collapsible stand attachment guide table section further comprises at least one leg assembly that folds down for use and folds up for storage.

19. The system of claim 12, wherein the controller is configured to receive information input by a user to calculate an appropriate position for placement of the moveable stop member and allow the user to place material on the system to be cut such that the useable material is disposed on the side opposite of the moveable stop member from the cutting tool.

20. The system of claim 12, wherein the controller is configured to receive information input by a user to calculate an appropriate position for placement of the moveable stop member and allow the user to place crown molding material flat on a table portion and against the fence portion of the collapsible stand attachment guide table sections for cutting.
